(19) United States
(12) Patent Application Publication
(10) Pub. No.: US 2004/0080524 A1
(43) Pub. Date: Apr. 29, 2004

(54) System and method for displaying patent analysis information

(76) Inventors: Chien-Fa Yeh, Tu-Chen (TW); Xin Cao, Shenzhen (CN); Chung-I Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/335,435

(22) Filed: Dec. 30, 2002

(30) Foreign Application Priority Data
Oct. 25, 2002 (TW) 91124863

(51) Int. Cl. G09G 5/00

(52) U.S. Cl. 345/700

(57) ABSTRACT

A system for displaying patent analysis information includes a patent information table (410), a dynamic classifying module (401), an XML (extensible markup language) converting module (310), an image converting module (320), and a user processing module (301). The patent information table stores a summary of patents. The dynamic classifying module defines different modes of classification, and has the function of classifying patents stored in the patent information table according to any one or more of said different modes. The XML converting module is used to convert patent classifications into XML documents. The image converting module is used to convert XML documents into star-hyperbolic trees each including a plurality of nodes. The user processing module is used to receive patent classification orders, and has the function of displaying star-hyperbolic trees on a display unit (250). A related method is also disclosed.

### FIELD OF THE INVENTION

The present invention relates to a system and method for analyzing data, and especially to a system and method for analyzing patent data and displaying patent analysis information.

### BACKGROUND OF THE INVENTION

Patents are becoming more and more important to a manufacturing business's success, especially in today's globalized economy. Patents can be viewed as a new type of currency in this global economy. A good way to make use of patents is to search and analyze public patent databases, which are vast storehouses of technological information. The patent databases provide not only information on technologies but also information on inventors and assignees of inventions. To search and analyze the patent databases is valuable for conducting activities such as licensing, infringement litigation, enforcement, technical research, and product development. Nowadays, numerous government patent offices have patent databases open to the public. Such offices include the United States Patent and Trademark Office (USPTO), the European Patent Office (EPO), the State Intellectual Property Office of the People's Republic of China (CPO), and the Japanese Patent Office (JPO). These patent databases are freely accessible through their respective web sites on the Internet.

However, few corporations conduct significant patent searching and analysis. One important reason for this is the difficulty in identifying relevant patents, and the difficulty in analyzing patents. Any major patent database contains an overwhelming number of patents, only a fraction of which are useful to a particular corporation. It is generally difficult for a corporation to efficiently search for useful patents. Even if the corporation finds useful patents, conducting patent analysis manually is a very difficult, tedious and time-consuming task.

Recently, technology for displaying information in image form has developed significantly. For example, U.S. Pat. No. 6,300,957 entitled “Mapping a node-link structure to a rendering space beginning from any node” discloses a method for converting a node-link structure into a hyperbolic tree. Through this technology, vast information can be shown in a simple image.

There are some software tools for patent analysis currently available. But analysis results produced by these tools tend to be rather simple and of limited relevance to the user. The tools are generally not adequate for analysis of very large numbers of patents required by a major analysis project. Thus the potential usefulness of huge databases of patents available online cannot be fully exploited.

### SUMMARY OF THE INVENTION

Accordingly, an objective of the present inversion is to provide a system for displaying patent analysis information in a star-hyperbolic tree.

Another objective of the present invention is to provide a method for displaying patent analysis information in a star-hyperbolic tree.

In order to achieve the first above-mentioned objective, a system for displaying patent analysis information in accordance with the present invention comprises a patent information table, a dynamic classifying module, an XML (extensible markup language) converting module, an image converting module and a user processing module. The patent information table stores a summary of patents. The dynamic classifying module defines different modes of classification, and has the function of classifying patents stored in the patent information table according to any one or more of said different modes. The XML converting module is used to convert patent classifications into XML documents. The image converting module is used to convert XML documents into star-hyperbolic trees each including a plurality of nodes. The user processing module is used to receive patent classification orders, and has the function of displaying star-hyperbolic trees on a display unit.

In order to achieve the second above-mentioned objective, a method for displaying patent analysis information in accordance with the present invention comprises the steps of: (a) downloading patent data from intellectual property information websites in accordance with a data downloading order received from a user; (b) mining patent summary information including patent number, patent assignee, filing date and international classification from documents in HTML (hypertext markup language) format, and storing the patent summary information in a patent information table; (c) classifying patents stored in the patent information table in accordance with a classification order from the user; (d) converting patent classification information into an XML document that includes a node data structure; and (e) converting the XML document into a star-hyperbolic tree which comprises a plurality of nodes, and displaying the star-hyperbolic tree on a display unit.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for displaying patent analysis information in accordance with a preferred embodiment of the present invention, the system comprising a database server, a file server, an application server and a plurality of client computers;

FIG. 2 is a schematic diagram of hardware infrastructure of one of the client computers of FIG. 1;

FIG. 3 is a schematic block diagram of function modules of said one client computer of FIG. 1;

FIG. 4 is a schematic block diagram of function modules of the application server of FIG. 1, and of communication among said one client computer, the application server, the database server and the file server;

FIG. 5A is an exemplary schematic illustration of a patent information table that is stored in the database server;

FIG. 5B is a block diagram of a patent classification tree in accordance with the present invention;

FIG. 5C illustrates an XML document corresponding to the patent classification tree of FIG. 5B;

FIG. 5D is a schematic illustration of the patent classification tree of FIG. 5B displayed in a display unit of said one client computer;

FIG. 6 is a flow chart of displaying patent analysis information according to the present invention;

FIG. 7 is a flow chart of one step of FIG. 6, namely generating a patent classification;

FIG. 8 is a flow chart of one step of FIG. 6, namely displaying a star-hyperbolic tree; and

FIG. 9 is a flow chart of one step of FIG. 8, namely converting a patent classification into an XML document.

### DETAILED DESCRIPTION OF PREFERRED EMBODIMENTS OF THE INVENTION

Reference will now be made to the drawings to describe the present invention in detail.

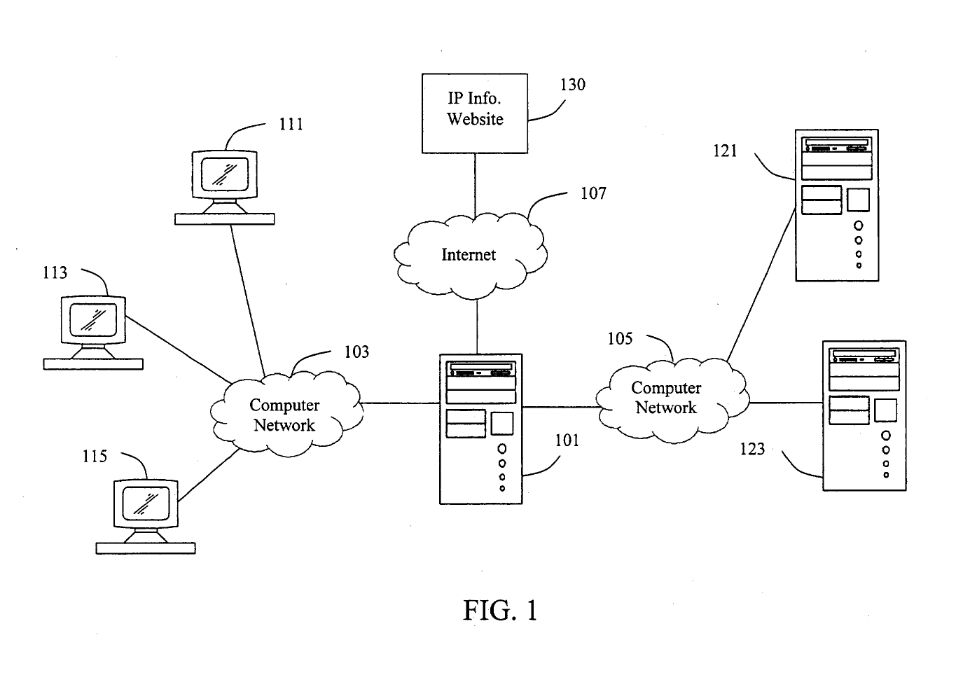

FIG. 1 is a schematic diagram of a system for displaying patent analysis information in accordance with a preferred embodiment of the present invention. The system for displaying patent analysis information comprises a three-layer information system. The three-layer information system comprises a data access layer, a business logic layer, and a presentation layer. The data access layer comprises a database server 121 and a file server 123. The business logic layer comprises an application server 101. The presentation layer comprises a plurality of client computers. For the purposes of conveniently illustrating the preferred embodiment of the present invention, three client computers 111, 113, 115 are shown and described hereinafter. Computer communication networks 103, 105 interconnect all the above-mentioned apparatuses. The application server 101 connects with a plurality of intellectual property information websites 130 (only one shown) via the Internet 107, and downloads patent information from the intellectual property information websites 130.

The application server 101 comprises core and mutable enterprise logic (such as rules, execution, and management) of the system for displaying patent analysis information. The application server 101 processes input of users, and returns results of processing to users. The database server 121 stores all structured data on an enterprise, and is used for managing processing of data stored in a database located in the database server 121. The file server 123 stores all unstructured data on the enterprise, and is used for managing processing of data stored in a database located in the file server 123. Such processing of the database server 121 and the file server 123 includes reading, writing, deleting, modifying, and backup. The client computers 111, 113, 115 have the function of receiving orders input by users, and displaying results of implementation of such orders.

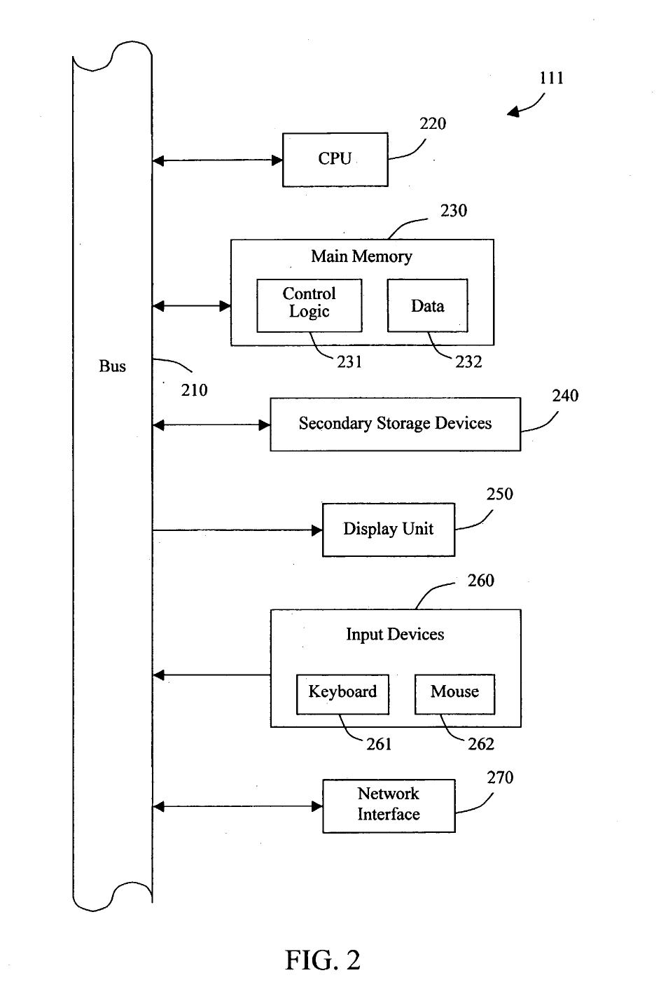

FIG. 2 is a schematic diagram of hardware infrastructure of the client computer 111. It should be noted that the client computers 113, 115, the application server 101, the database server 121 and the file server 123 each comprise hardware infrastructure similar to that of the client computer 111. The client computer 111 comprises the following units: a central processing unit (CPU) 220, a main memory 230, a plurality of secondary storage devices 240, a display unit 250, a plurality of input devices 260, and one or more network interfaces 270. Each of said units is connected with a common system bus 210, to communicate with other of said units.

The CPU 220 is the functional core of the client computer 111, and is used for processing all computing tasks in the client computer 111. The bus 210 is used for data exchange among the units in the client computer 111. The main memory 230 is high-speed random access memory (RAM) and read only memory (ROM), and comprises storage areas for control logic 231 and data 232. The main memory 230 may also include any additional or alternative high-speed memory device or memory circuitry. The secondary storage devices 240 are used to store all application programs and other data on the enterprise. The secondary storage devices 240 are preferably long term storage devices. Such devices may include ROM, optical or magnetic disks, organic memory, or any other suitable volatile or non-volatile mass storage system. The display unit 250 displays prompting information for users. Such information assists users to input orders for processing of data, and to view results of implementation of such orders. The input devices 260 receive control orders from users, and comprise a keyboard 261 and a mouse 262. Each network interface 270 controls communication between the client computer 111 and other computer devices.

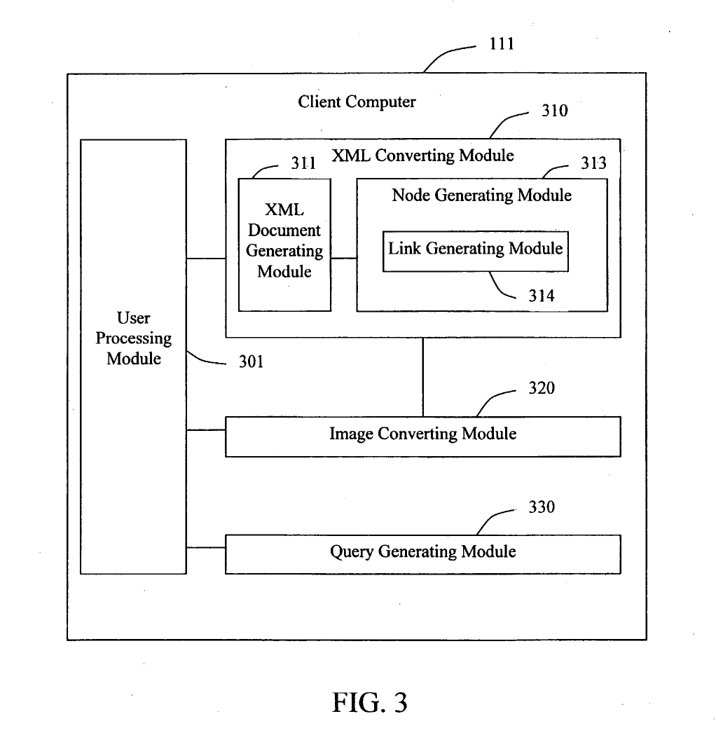

FIG. 3 is a schematic block diagram of function modules of the client computer 111. The client computer 111 comprises a user processing module 301, an XML (Extensible Markup Language) converting module 310, an image converting module 320, and a query generating module 330.

The user processing module 301 comprises a Graphical User Interface (GUI) for users to input data processing orders. The GUI also displays results of implementation of the orders via the display unit 250. The user processing module 301 is connected with the XML converting module 310 and the query generating module 330, for sending of user orders thereto. The user processing module 301 is also connected with the image converting module 320, for receiving results of implementation of the user orders therefrom.

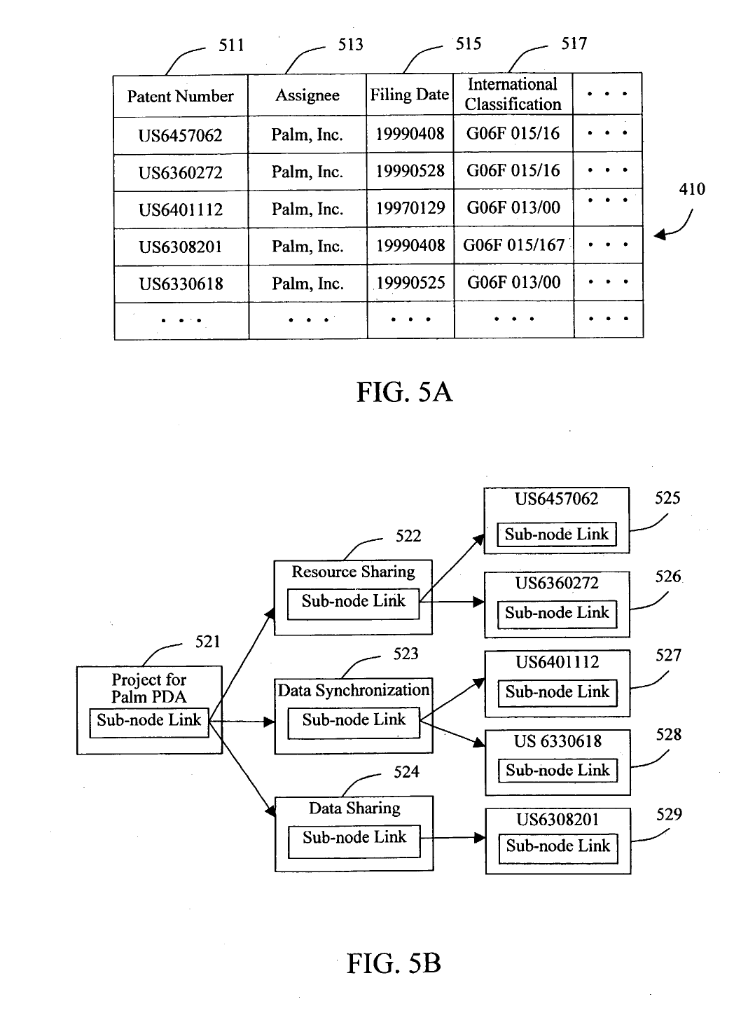

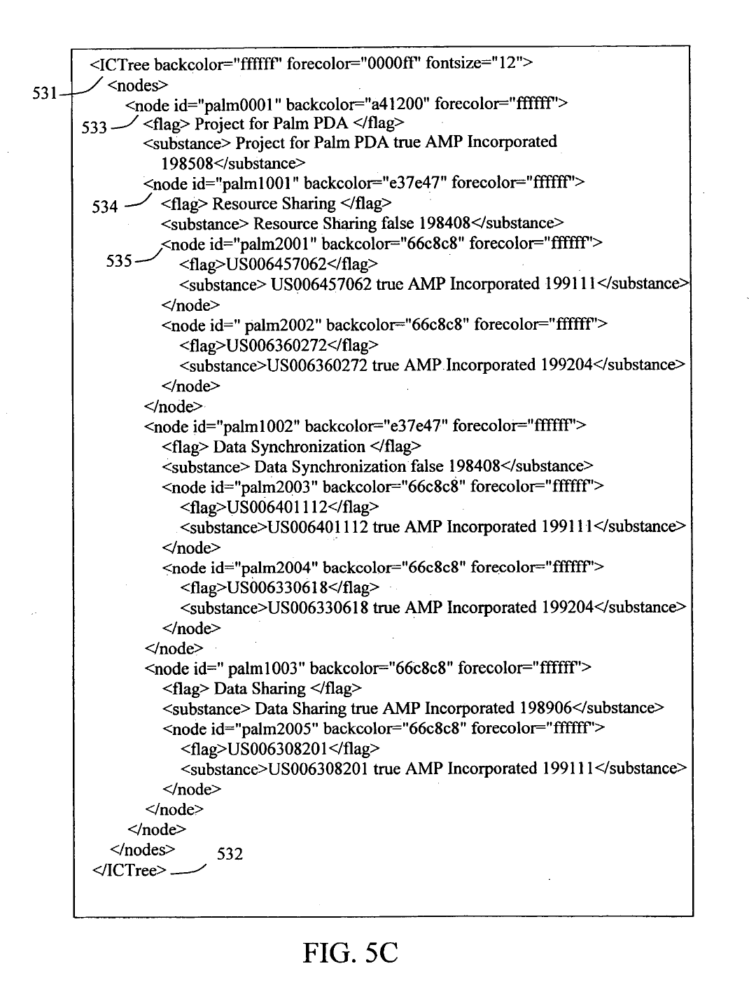

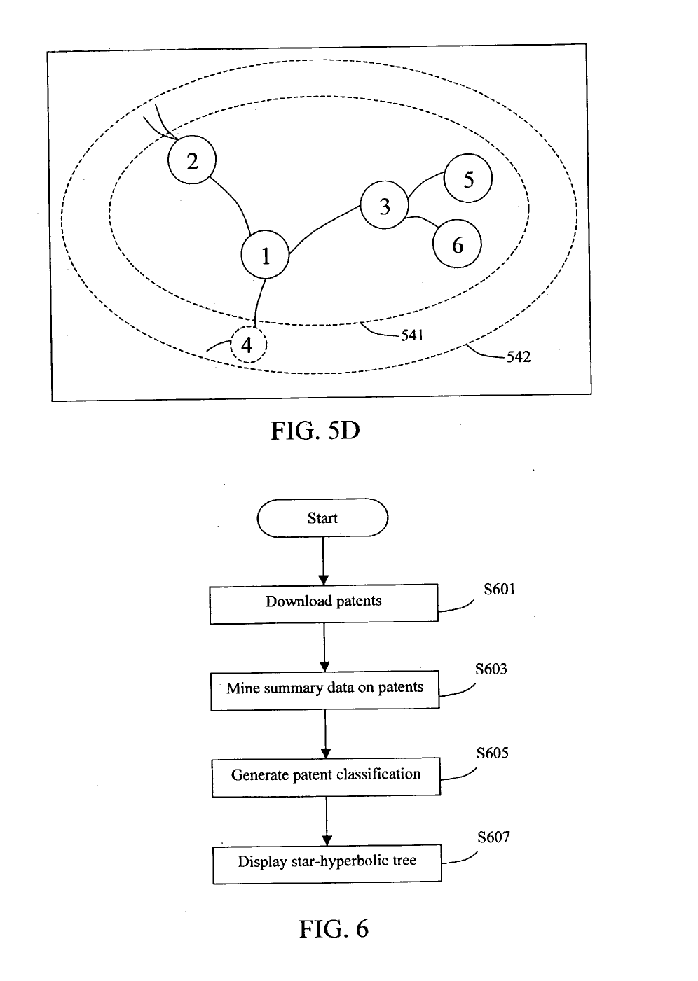

The XML converting module 310 is used for converting data stored in the database server 121 into an XML document having particular data structures. Such conversion is described in detail below with reference to FIG. 5C. The XML converting module 310 comprises an XML document generating module 311, and a node generating module 313. The node generating module 313 packs patent analysis data into a node data structure. Such packing is described in detail below with reference to FIG. 5B. The node generating module 313 further comprises a link generating module 314. The link generating module 314 generates links between nodes, and adds the links to the node data structure. The XML document generating module 311 generates an empty XML document, and stores the node data structure generated in the node generating module 313 in the XML document. The XML document is a temporary document stored in data 232 of the main memory 230 of the client computer 111.

The image converting module 320 converts the XML document into a star-hyperbolic tree. The star-hyperbolic tree includes a plurality of nodes and links between the nodes. The structure of the star-hyperbolic tree is described in detail below with reference to FIG. 5D.

The query generating module 330 converts patent downloading orders input by users via the user processing module 301 into queries that the application server 101 can read, and sends the queries to the application server 101.

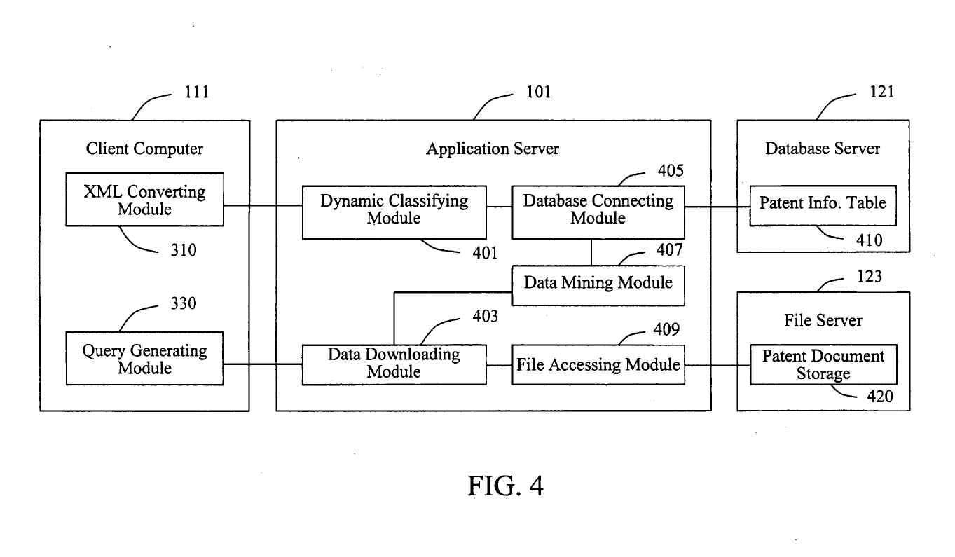

FIG. 4 is a schematic block diagram of function modules of the application server 101, and of communication among the client computer 111, the application server 101, the database server 121 and the file server 123. The application server 101 comprises a dynamic classifying module 401, a database connecting module 405, a data mining module 407, a data downloading module 403, and a file accessing module 409.

The database connecting module 405 is used for connecting the application server 101 with the database server 121. The database connecting module 405 controls data communication between applications and source data. Applications of the application server 101 can access data stored in different database management systems (DBMSs) via the database connecting module 405. In the preferred embodiment of the present invention, the applications can access data stored in a patent information table 410 that is stored in the database server 121. The patent information table 410 is described in detail below with reference to FIG. 5A. The file accessing module 409 connects the application server 101 with the file server 123. Applications of the application server 101 can access data stored in a patent document storage 420 of the file server 123.

The data downloading module 403 receives patent downloading queries from the query generating module 330 of the client computer 111. The data downloading module 403 downloads patents from the IP information websites 130 via the Internet 107 (see FIG. 1) in accordance with the patent downloading queries. The downloaded patents are in the form of electronic documents, typically including HTML format documents. The downloaded patents are stored in the file server 123 via the file accessing module 409, and summary data on patents in HTML format are sent to the data mining module 407.

The data mining module 407 mines the summary data on patents in HTML format, using tags contained in the relevant HTML files as identifiers. The summary data on patents include the following information on each patent: title, assignee, inventor, and filing date. The summary data on patents are stored in the patent information table 410 via the database connecting module 405.

In the preferred embodiment of the present invention, patents are divided into a plurality of projects. Each project comprises a plurality of patents having some commonality. The commonality may, for example, be a same assignee within a same area of technology. Summary data on each patent in a same project are stored in a same patent information table 410. The dynamic classifying module 401 is used for classifying patents according to different criteria, in accordance with user orders. Such classifications may be according to area of technology, assignee, time frame within which applications for patent were filed, and so on.

The above-mentioned modules described in relation to FIGS. 3 and 4 can also be comprised in a single computer device, and the single computer device can achieve all functions of the system for displaying patent analysis information. FIGS. 5A-5D are provided in relation to classification of patents according to area of technology.

FIG. 5A is an exemplary schematic illustration of the patent information table 410. The patent information table 410 comprises columns for patent number 511, assignee 513, filing date 515, and international classification 517. All data stored in the patent information table 410 have been mined from patent documents downloaded from the IP information websites 130.

The column for patent number 511 stores patent numbers of patents. The patents may be completely or partially stored in the patent document storage 420 of the file server 123. The column for assignee 513 stores assignee names of corresponding patents. The column for filing date 515 stores application dates of corresponding patents. The column for international classification 517 stores classification codes of corresponding patents.

The column for international classification 517 is used for classifying patents by area of technology. The titles of sub-classes of classes are pre-defined in accordance with the international classification of patents. If a patent has more than one international classification, the first-named international classification in the patent is used as the classification of the patent. A user can also define titles of supra-classes of classes, each supra-class including two or more international classifications.

The patent information table 410 illustrated is exemplary of the preferred embodiment of the present invention. In alternative embodiments, the patent information table 410 may include one or more other columns in lieu of and/or in addition to the above-described columns 511, 513, 515, 517. Such other columns can provide other summary data on patents. Furthermore, the patent information table 410 may instead be replaced by two or more similar tables.

FIG. 5B is a block diagram of a patent classification tree in accordance with the present invention. The patent classification tree comprises a plurality of nodes. Each node comprises a sub-node link connecting the node with its respective sub-nodes.

The patent classification tree is generated in accordance with data stored in the patent information table 410. The dynamic classifying module 401 classifies patents having a same international classification into a same sub-class, according to the summary data stored in the patent information table 410. The node generating module 313 of the client computer 111 generates a node data structure. The link generating module 314 generates sub-node links between the nodes, and adds sub-node links to the node data structure. Each sub-node link connects one node with its respective one or more sub-nodes. In some program languages, functions of the sub-node link are activated by using a pointer or a cursor.

The patent classification tree comprises three types of nodes in the area of technology classification. The first type of node is a patent node, such as 525, 526, 527, 528, and 529. The patent nodes 525-529 are the last layer of nodes in the patent classification tree. The patent numbers are used as default labels of the patent nodes when the patent classification tree is shown in picture format. Other default labels such as patent title can also be used. The node data structure can also include patent summary data such as assignee, filing date, and title of each patent.

The second type of node is a classification node, such as 522, 523, and 524. The classification nodes 522-524 can also be divided into sub-classifications to indicate more detailed areas of technology. The classification nodes link to the patent nodes or to sub-classification nodes. Classification names are used as labels of the classification nodes and the sub-classification nodes.

The third type of node is a project node, such as 521. The project node 521 uses a project name as its label, and links to the classification nodes 522-524.

FIG. 5C illustrates an XML document corresponding to the patent classification tree of FIG. 5B. First, the source data upon which the invention operates must be specified using an outer-level grouping construct such as the beginning tag syntax “<ICTree backcolor=“ffffff” forecolor=“0000ff” fontsize=“12”>” shown at 531 and the ending tag syntax “</ICTree>” shown at 532. Other keywords, such as “node,” may be used in these outermost tags. FIG. 5C also illustrates that within the outmost structure, any number of nested substructures such as “node” may exist. What is required is that a predetermined keyword syntax is used to specify the source data. The gathering process performed by the image converting module 320 searches for this keyword syntax during conversion of the XML document into a patent classification tree in picture format. The value of “id” (identifier) within this construct can be any syntactically correct value according to XML syntax, and will be used by the image converting module 320 to locate the corresponding source data.

FIG. 5C further illustrates that the XML document contains contents for node data structure and links between nodes. For example, the data item having the identifier “backcolor” has the value “a41200.” “a41200” is a value of an RGB (Red Green Blue) color combination, which yields the color orange. Accordingly, the background color of node 533 is orange. The identifier “id=“palm10001”” means that the ID of node 533 is “palm10001” in the patent classification tree. The identifier “<flag> Project for Palm PDA </flag>” means that the title of the node 533 is “Project for Palm PDA.” The nested structure of node data in the XML document corresponds to links between the nodes. For example, the corresponding node of identifier 534 is a sub-node of the corresponding node of identifier 533, and is a supra-node of the corresponding node of identifier 535.

FIG. 5D is a schematic illustration of the patent classification tree of FIG. 5B displayed in the display unit 250 of the client computer 111. The image converting module 320 reads the XML document stored in the main memory 230 of the client computer 111, converts the XML document into a star-hyperbolic tree, and displays the star-hyperbolic tree in a hyperbolic plane in the display unit 250. A user can adjust a shape of the star-hyperbolic tree by dragging or clicking the mouse 262 of the client computer 111. The user can also read details of a patent by double-clicking a patent node. The nodes may be circular, or may be configured to have other shapes.

The hyperbolic plane is divided into three areas. The first area is inside an ellipse 541, and is named a visible area. In the visible area, nodes and links between the nodes are all visible, such as the 1, 2, 3, 5, and 6 nodes. The second area is between the ellipse 541 and an ellipse 542, and is named a half-visible area. In the half-visible area, the nodes are invisible, and each one is replaced by a kind of dot. However, links between the nodes are visible, such as the links of node 4. The third area is outside the ellipse 542, and is named an invisible area. In the invisible area, the nodes and links between the nodes are all invisible.

FIG. 6 is a flow chart of displaying patent analysis information according to the present invention. Firstly, in step S601, the GUI of the user processing module 301 receives a patent downloading order from a user, and the data downloading module 403 downloads patents in accordance with the user order. In step S603, the data mining module 407 mines summary data on patents in HTML format, using tags contained in the relevant HTML files as identifiers. The summary data on patents include patent numbers, assignees, filing dates, and international classifications. The summary data on patents are stored in corresponding columns of the patent information table 410 via the database connecting module 405. The patent documents are stored in the patent document storage 420 via the file accessing module 409.

In step S605, when the user inputs a patent classifying order, the dynamic classifying module 401 reads the patent information table 410 via the database connecting module 405, generates a patent classification in accordance with the user order, and stores the patent classification in a main memory of the application server 101. In step S607, the XML converting module 310 generates a plurality of nodes in accordance with the patent classification. The nodes include classification nodes and patent nodes. The nodes are arranged into a node data structure, and stored in an XML document. The image converting module 320 converts the XML document into a star-hyperbolic tree, and displays the star-hyperbolic tree in the display unit 250.

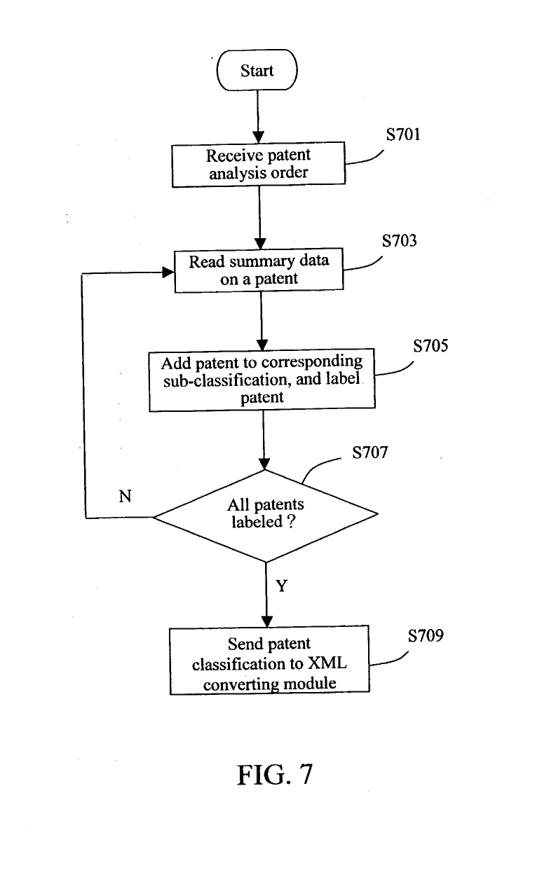

FIG. 7 is a flow chart of step S605 of FIG. 6, namely generating a patent classification. In step S701, the GUI of the user processing module 301 receives a patent analysis order from the user. In step S703, the dynamic classifying module 401 reads the summary data on a patent from the corresponding column of the patent information table 410. In step S705, the dynamic classifying module 401 adds the patent to a corresponding sub-classification, and marks the patent with a classification label in the patent information table 410. In step S707, the dynamic classifying module 401 checks the patent information table 410, and determines whether all the patents therein are marked with classification labels. If all the patents are not marked with classification labels, the procedure returns back to S703. If and when all the patents are marked with classification labels, in step S709, the dynamic classifying module 401 sends the patent classification to the XML converting module 310, whereupon the procedure is ended.

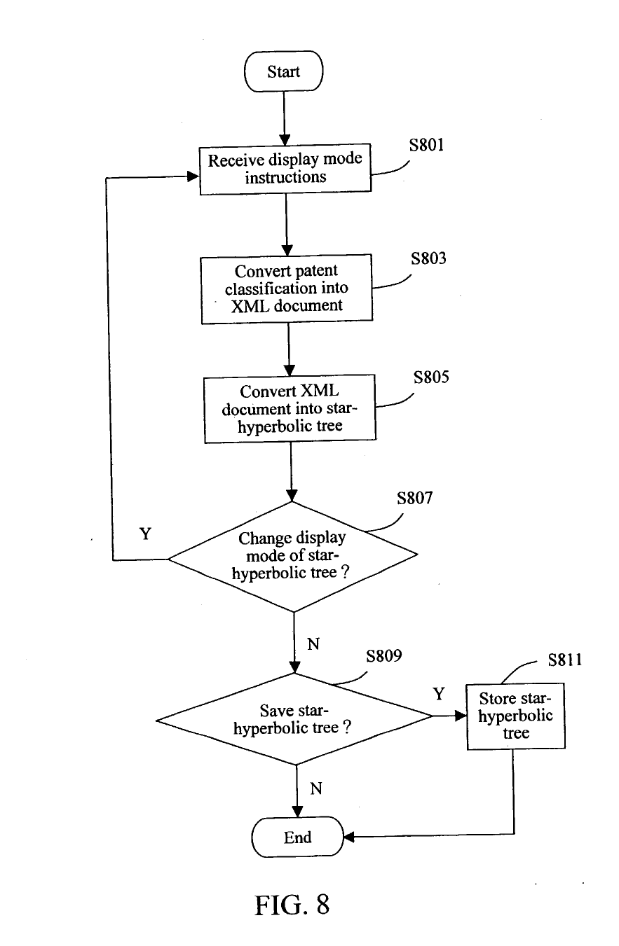

FIG. 8 is a flow chart of step S607 of FIG. 6, namely displaying a star-hyperbolic tree. In step S801, the dynamic classifying module 401 receives instructions on a mode of displaying the star-hyperbolic tree. For example, the star-hyperbolic tree can display patent numbers on patent nodes, or display assignees on patent nodes. In step S803, the XML converting module 310 converts the patent classification generated by the dynamic classifying module 401 into an XML document. In step S805, the image converting module 320 converts the XML document into a star-hyperbolic tree, and displays the star-hyperbolic tree in the display unit 250.

In step S807, the GUI of the user processing module 301 receives an order from the user, and determines whether to change the mode of displaying the star-hyperbolic tree having regard to the user order. If the user wants to see another display mode, the procedure returns to step S801. If the user does not want to see another display mode, in step S809, the GUI of the user processing module 301 determines whether to save the star-hyperbolic tree having regard to the user order. If the user does not want to save the star-hyperbolic tree, the procedure is ended. If the user wants to save the star-hyperbolic tree, in step S811, the user processing module 301 stores the star-hyperbolic tree in the secondary storage devices 240, whereupon the procedure is ended.

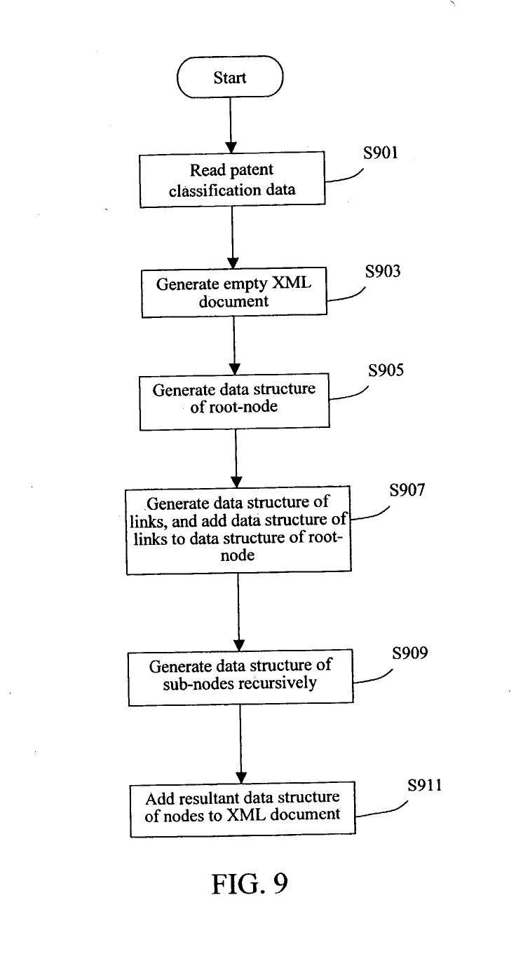

FIG. 9 is a flow chart of step S803 of FIG. 8, namely converting a patent classification into an XML document. In step S901, the XML converting module 310 reads the patent classification data. In step S903, the XML document generating module 311 generates an empty XML document for storing of the patent classification information. In step S905, the node generating module 313 generates data structure of a root-node. The data structure of the root-node includes ID, background color, foreground color, flag of the node, and so on. In step S907, the link generating module 314 generates data structure of links between the root-node and other nodes, and adds the data structure of links to the data structure of the root-node. In step S909, the node generating module 313 and the link generating module 314 recursively generate data structure of sub-nodes. In step S911, the XML document generating module 311 adds the resultant data structure of nodes to the XML document.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for displaying patent analysis information, the system comprising a patent information table, a dynamic classifying module, an extensible markup language (XML) converting module, an image converting module and a user processing module; wherein:
the patent information table stores a summary of patents;
the dynamic classifying module defines different modes of classification, and has the function of classifying patents stored in the patent information table according to any one or more of said different modes;
the XML converting module is used to convert patent classifications into XML documents;
the image converting module is used to convert XML documents into star-hyperbolic trees each including a plurality of nodes; and
the user processing module is used to receive patent classification orders, and has the function of displaying star-hyperbolic trees on a display unit.

2. The system as claimed in claim 1, wherein the patent information table, the dynamic classifying module, the XML converting module, the image converting module and the user processing module are included in a single computing device.

3. The system as claimed in claim 1, wherein the patent information table is included in a database server, the dynamic classifying module is included in an application server, the XML converting module, the image converting module and the user processing module are included in a client computer, and the database server, the application server and the client computer -are connected by a network.

4. The system as claimed in claim 1, wherein any one or more of the patent classification orders are to classify patents by area of technology.

5. The system as claimed in claim 1, wherein any one or more of the patent classification orders are to classify patents by patent assignee name.

6. The system as claimed in claim 1, wherein any one or more of the patent classification orders are to classify patents by time frame within which applications for patent were filed.

7. The system as claimed in claim 1, further comprising a data downloading module for downloading patent data from at least one intellectual property information website.

8. The system as claimed in claim 1, further comprising a data mining module for mining patent summary data from documents in hypertext markup language (HTML) format.

9. The system as claimed in claim 1, wherein the patent information table comprises columns for patent number, assignee, filing date, and international classification.

10. The system as claimed in claim 1, wherein nodes of each of the star-hyperbolic trees comprise patent nodes, classification nodes, and project nodes.

11. The system as claimed in claim 1, wherein a display of each of the star-hyperbolic trees is divided into a visible area, a half-visible area, and an invisible area.

12. A method for displaying patent analysis information, the method comprising the steps of:
downloading patent data from at least one intellectual property information website in accordance with a data downloading order received from a user;
mining patent summary information including patent number, patent assignee, filing date and international classification from documents in hypertext markup language (HTML) format, and storing the patent summary information in a patent information table;
classifying patents stored in the patent information table in accordance with a classification order from the user;
converting patent classification information into an extensible markup language (XML) document that includes a node data structure; and
converting the XML document into a star-hyperbolic tree which comprises a plurality of nodes, and displaying the star-hyperbolic tree on a display unit.

13. The method as claimed in claim 12, wherein the step of converting patent classification information into the XML document further comprises the steps of:
generating a data structure of nodes in accordance with patent classification information;
generating link information, and adding the link information into the data structure of nodes; and
generating an empty XML document, and adding the data structure of nodes into the XML document.

14. The method as claimed in claim 12, wherein nodes of the star-hyperbolic tree comprise patent nodes, classification nodes, and project nodes.

15. The method as claimed in claim 12, wherein the display of the star-hyperbolic tree comprises a visible area, a half-visible area, and an invisible area.

16. The method as claimed in claim 12, wherein said nodes are categorically displayed by two different colors of which, one represents data resulting from a center star of said star-hyperbolic tree while the other represents data resulting in the center star of said star-hyperbolic tree.
